(19) United States
(12) Patent Application Publication
(10) Pub. No.: US 2026/0328101 A1
(43) Pub. Date: Oct. 22, 2026

(54) SKEWED TAB PLY AIRFOIL-PLATFORM AND METHOD

(71) Applicant: RTX Corporation, Farmington, CT (US)

(72) Inventors: Kathryn S READ, Marlborough, CT (US); Cheng GAO, South Glastonbury, CT (US)

(73) Assignee: RTX Corporation, Farmington, CT (US)

(21) Appl. No.: 19/182,348

(22) Filed: Apr. 17, 2025

(51) Int. Cl. F01D 5/28; B28B 1/42

(52) U.S. Cl. CPC F01D 5/282; B28B 1/42; F01D 5/284; F05D 2300/6033

(57) ABSTRACT

A ceramic matrix composite (CMC) component or a preform for making a CMC component, may be provided. The component or preform may comprise: a first platform; an airfoil extending from the first platform, the airfoil comprising a first airfoil side and a second airfoil side; and a first tab ply extending from the first airfoil side into the first platform at a skewed angle. Methods of fabrication of a CMC component comprising at least one skewed tab ply.

### FIELD OF THE INVENTION

The subject matter disclosed herein relates to composite architectures, and, in particular, relates to ceramic matrix composite airfoils with platform(s) comprising plies having skewed tabs and methods of fabrication thereof.

### BACKGROUND OF THE INVENTION

Gas turbine engines or jet engines, in general, include a fan section, a compressor section, a combustion section, and a turbine section. Air enters through the fan section and is compressed in the compressor section before being introduced into the combustion section. In the combustion section, the air is mixed with fuel and ignited to generate a high-energy, high temperature gas flow. The high-energy, high temperature gas flow is expanded in the turbine section which is used to create thrust and to drive the compressor and fan sections.

Certain components of gas turbine engines are thus exposed to the high-energy, high temperature gas flow (i.e., gaspath components). Therefore, ceramic matrix composites (CMCs) may be desirable for use in gas turbine engines due to their unique material properties including high temperature and oxidation resistance capabilities, high strength and creep resistance, high thermal conductivity, and low weight.

CMC components may be fabricated by laying up one or more ceramic fibers and/or ceramic fabrics in a preform. Certain gas turbine engine components, such as airfoils with platforms, can include complex curvatures and/or other features for which conventional layup techniques may result in distortions and reduced fiber regions in the preform. Techniques such as use of more than one ply of ceramic fabric joined together to create a layer of a preform may reduce defects, but joining of plies may also result in structure with reduced numbers and/or density of continuous load carrying fibers as compared to continuous plies.

There exists a continuing need for materials, methods, and techniques for producing airfoils with platforms comprising relatively increased numbers and/or density of continuous load carrying fibers.

The above information disclosed in this Background section is only for understanding of the background of the inventive concepts and, therefore, it may contain information that does not constitute prior art.

### SUMMARY OF THE INVENTION

The present disclosure is directed, in a first embodiment, to a ceramic matrix composite (CMC) component or a preform for making a CMC component, comprising: (a) a first platform; (b) an airfoil extending from the first platform, the airfoil comprising a first airfoil side and a second airfoil side; and (c) a first tab ply extending from at least the first airfoil side onto the first platform and comprising (i) at least one airfoil side portion that forms at least a portion of at least the first airfoil side and (ii) at least one first skewed tab portion that forms at least a portion of a first area of the first platform.

In further embodiments of the present disclosure, including further embodiments of the above exemplary embodiments, the CMC component or preform further comprises: a second tab ply extending from at least the second airfoil side onto the first platform and comprising (i) at least one airfoil side portion that forms at least a portion of the second airfoil side and (ii) at least one second skewed tab portion that forms at least a portion of a second area of the first platform.

In further embodiments of the present disclosure, including further embodiments of the above exemplary embodiments, the first tab ply further comprises at least one first unskewed tab portion that forms at least a portion of a third area of the first platform In further embodiments of the present disclosure, including further embodiments of the above exemplary embodiments, the second tab ply further comprises at least one second unskewed tab portion that forms at least a portion of a fourth area of the first platform.

In further embodiments of the present disclosure, including further embodiments of the above exemplary embodiments, the CMC component or preform further comprises a second platform, wherein the airfoil extends between the first platform and the second platform, wherein the first tab ply extends from at least the first airfoil side onto the second platform and further comprises at least one third skewed tab portion that forms at least a portion of a first area of the second platform.

In further embodiments of the present disclosure, including further embodiments of the above exemplary embodiments, the second tab ply extends from at least the second airfoil side onto the second platform and further comprises at least one fourth skewed tab portion that forms at least a portion of a second area of the second platform.

In further embodiments of the present disclosure, including further embodiments of the above exemplary embodiments, the first tab ply extends from at least the first airfoil side onto the second platform and further comprises at least one third unskewed tab portion that forms at least a portion of a third area of the second platform.

In further embodiments of the present disclosure, including further embodiments of the above exemplary embodiments, the second tab ply extends from at least the second airfoil side onto the second platform and further comprises at least one fourth unskewed tab portion that forms at least a portion of a fourth area of the second platform In further embodiments of the present disclosure, including further embodiments of the above exemplary embodiments, the first tab ply comprises at least one or at least a plurality of longitudinal ceramic fiber that is continuous along its entire length from the first skewed tab portion to the third skewed tab portion.

In further embodiments of the present disclosure, including further embodiments of the above exemplary embodiments, the second tab ply comprises at least one or at least a plurality of longitudinal ceramic fiber that is continuous along its entire length from the second skewed tab portion to the fourth skewed tab portion.

In further embodiments of the present disclosure, including further embodiments of the above exemplary embodiments, the first tab ply and the second tab ply together form one ply that is at least partially continuous circumferentially around the airfoil.

In another embodiment, the present disclosure is directed to a method of forming a ceramic matrix composite (CMC) component, comprising: (a) forming an airfoil by applying one or more ceramic fabric plies to a mandrel, the airfoil comprising a first airfoil side and a second airfoil side; (b) forming a first platform at a first end of the airfoil by applying one or more ceramic fabric plies, (i) the first platform and the first airfoil side forming a first fillet at an interface formed therebetween and (ii) the first platform and the second airfoil side forming a second fillet at an interface formed therebetween; (c) providing at least one ceramic fabric first tab ply; the first tab ply comprising (i) at least one first airfoil side portion (ii) at least one first platform portion; and (d) applying the first tab ply by (i) applying the at least one first airfoil side portion to the first airfoil side and (ii) wrapping at least one of the at least one first platform portion around at least a portion of the first fillet onto the first platform at at least one skewed angle, such that a first skewed tab is formed.

In further embodiments of the present disclosure, including further embodiments of the above exemplary embodiments, the method further comprises: making one or more cuts in the first platform portion in a direction extending longitudinally with respect to a central axis of the airfoil, forming at least two first platform portions; wrapping at least one of the at least two first platform portions around at least a portion of the first fillet onto the first platform at at least a first skewed angle, such that a first skewed tab is formed in a first location of the first platform; and wrapping at least another of the at least two first platform portions around at least a portion of the first fillet onto the first platform at at least a second skewed angle, such that a second skewed tab is formed in a second location of the first platform, wherein the first skewed angle and the second skewed angle are the same or different.

In further embodiments of the present disclosure, including further embodiments of the above exemplary embodiments, the method further comprises: making two or more cuts in the first platform portion in a direction extending longitudinally with respect to a central axis of the airfoil, forming at least three first platform portions; wrapping at least one of the at least three first platform portions around at least a portion of the first fillet onto the first platform at at least a first skewed angle, such that a first skewed tab is formed in a first location of the first platform; wrapping at least another of the at least three first platform portions around at least a portion of the first fillet onto the first platform at at least a second skewed angle, such that a second skewed tab is formed in a second location of the first platform, wherein the first skewed angle and the second skewed angle are the same or different; and wrapping at least another of the at least three first platform portions around at least a portion of the first fillet onto the first platform at at least a first unskewed angle, such that a first unskewed tab is formed in a third location of the first platform.

In further embodiments of the present disclosure, including further embodiments of the above exemplary embodiments, the method further comprises (e) providing at least one ceramic fabric second tab ply; the second tab ply comprising (i) at least one first airfoil side portion (ii) at least one first platform portion; and (f) applying the second tab ply by (i) applying the at least one first airfoil side portion to the second airfoil side and (ii) wrapping at least one of the at least one first platform portion around at least a portion of the second fillet onto the first platform at at least one skewed angle, such that a second skewed tab is formed.

In further embodiments of the present disclosure, including further embodiments of the above exemplary embodiments, the first tab ply further comprises (iii) at least one second platform portion; and the method further comprises (e) forming a second platform at a second end of the airfoil by applying one or more ceramic fabric plies; (i) the second platform and the first airfoil side forming a third fillet at an interface formed therebetween and (ii) the second platform and the second airfoil side forming a fourth fillet at an interface formed therebetween; and (f) wrapping at least one of the at least one second platform portion of the first tab ply around at least a portion of the third fillet onto the second platform at at least one skewed angle, such that a second skewed tab is formed, wherein the first skewed tab and the second skewed tab are skewed at the same or different angles.

In further embodiments of the present disclosure, including further embodiments of the above exemplary embodiments, the second tab ply further comprises (iii) at least one second platform portion; and the method further comprises: (g) forming a second platform at a second end of the airfoil by applying one or more ceramic fabric plies; (i) the second platform and the first airfoil side forming a third fillet at an interface formed therebetween and (ii) the second platform and the second airfoil side forming a fourth fillet at an interface formed therebetween; and (h) wrapping at least one of the at least one second platform portion of the second tab ply around at least a portion of a fourth fillet onto the second platform at at least one skewed angle, such that a third skewed tab is formed, wherein the first skewed tab, the second skewed tab, and the third skewed tab are independently skewed at the same or different angles.

In further embodiments of the present disclosure, including further embodiments of the above exemplary embodiments, the method further comprises (g) providing at least one ceramic fabric second tab ply, the second tab ply further comprising (i) at least one first airfoil side portion, (ii) at least one first platform portion, and (iii) at least one second platform portion; and (h) applying the second tab ply by (i) applying the at least one first side portion to the second airfoil side; (ii) wrapping at least one of the at least one first platform portion around at least a portion of a second fillet onto the first platform at at least one skewed angle, such that a third skewed tab is formed; and (iii) wrapping at least one of the at least one second platform portion of the second tab ply around at least a portion of the fourth fillet onto the second platform at at least one skewed angle, such that a fourth skewed tab is formed, wherein the first skewed tab, the second skewed tab, the third skewed tab, and the fourth skewed tab are independently skewed at the same or different angles.

In further embodiments of the present disclosure, including further embodiments of the above exemplary embodiments, the first tab ply comprises at least one or at least a plurality of longitudinal ceramic fiber that is continuous along its entire length from the first skewed tab portion to the airfoil to the optional third skewed tab portion.

In further embodiments of the present disclosure, including further embodiments of the above exemplary embodiments, the first tab ply comprises at least one or at least a plurality of longitudinal ceramic fiber that is continuous along its entire length from the first skewed tab portion to the airfoil portion to the optional third skewed tab portion.

In further embodiments of the present disclosure, including further embodiments of the above exemplary embodiments, the first tab ply and the second tab ply together form one ply that is at least partially continuous circumferentially around the airfoil.

### BRIEF DESCRIPTION OF FIGURES

The features of the disclosure believed to be novel and the elements characteristic of the invention are set forth with particularity in the appended claims. The figures are for illustration purposes only and are not drawn to scale. The disclosure itself, however, both as to organization and method of operation, can best be understood by reference to the description of the preferred embodiment(s) which follows, taken in conjunction with the accompanying drawings in which:

FIG. 1 schematically illustrates a partial cross section of an exemplary gas turbine engine.

FIG. 2 is a perspective view of a non-limiting exemplary vane, which may be provided in, e.g., turbomachinery, such as a gas turbine engine.

FIG. 3A and FIG. 3B each illustrates a perspective view of view of non-limiting exemplary vane comprising a non-limiting exemplary tab ply.

FIG. 4A and FIG. 4B each illustrates a perspective view of view of non-limiting exemplary vane comprising a non-limiting exemplary tab ply.

FIG. 5 is a perspective view of a non-limiting exemplary vane similar to vane comprising a non-limiting exemplary flange and non-limiting exemplary tab plies.

FIG. 6 is a flowchart illustrating an exemplary method of fabricating an exemplary vane.

### DETAILED DESCRIPTION OF THE INVENTION

The subject matter disclosed herein relates to ceramic matrix composite (CMC) airfoil(s) extending at least from one platform and methods of fabrication thereof, and more particularly to a CMC airfoil wherein one or more airfoil ply tab extending from one or more airfoil portion into one or more platform portion is intentionally skewed for a structural benefit.

The embodiments of the present disclosure can comprise, consist of, and consist essentially of the features and/or steps described herein, as well as any of the additional or optional ingredients, components, steps, or limitations described herein or that would otherwise be appreciated by one of skill in the art.

The following discussion omits or only briefly describes conventional features of the disclosed technology that are apparent to those skilled in the art. Reference to a particular embodiment does not limit the scope of the claims attached hereto. Additionally, any examples set forth in this specification are intended to be non-limiting and merely set forth some of the many possible embodiments for the appended claims. Further, particular features described herein can be used in combination with other described features in each of the various possible combinations and permutations. A person of ordinary skill in the art would know how to use the instant invention, in combination with routine experiments, to achieve other outcomes not specifically disclosed in the examples or the embodiments.

Unless otherwise specifically defined herein, all terms are to be given their broadest possible interpretation including meanings implied from the specification as well as meanings understood by those skilled in the art and/or as defined in dictionaries, treatises, etc. Unless defined otherwise, all technical and scientific terms used herein have the same meaning as commonly understood by one of ordinary skill in the art in the field of the disclosed technology. It must also be noted that, as used in the specification and the appended claims, the singular forms “a,” “an,” and “the” include plural referents unless otherwise specified, and that the terms “includes” and/or “including,” when used in this specification, specify the presence of stated features, elements, and/or components, but do not preclude the presence or addition of one or more other features, steps, operations, elements, components, and/or groups thereof. Additionally, methods, equipment, and materials similar or equivalent to those described herein can also be used in the practice or testing of the disclosed technology.

The devices of the present disclosure may be understood more readily by reference to the following detailed description of the embodiments taken in connection with the accompanying drawing figures, which form a part of this disclosure. It is to be understood that this application is not limited to the specific devices, methods, conditions or parameters described and/or shown herein, and that the terminology used herein is for the purpose of describing particular embodiments by way of example only and is not intended to be limiting. All spatial references, such as, for example, proximal, distal, horizontal, vertical, top, upper, lower, bottom, left and right, are for illustrative purposes only and can be varied within the scope of the disclosure. For example, the references “upper” and “lower” are relative and used only in the context to the other, and are not necessarily “superior” and “inferior.”

It will further be understood that, although the terms “first,” “second,” “third,” and the like may be used herein to describe various elements, these elements should not be limited by these terms. These terms are only used to distinguish one element from another element. Thus, “a first element” discussed below could be termed “a second element” or “a third element,” and “a second element” and “a third element” may be termed likewise without departing from the teachings herein.

Various examples of the disclosed technology are provided throughout this disclosure. The use of these examples is illustrative only, and in no way limits the scope and meaning of the invention or of any exemplified form. Likewise, the invention is not limited to any particular preferred embodiment(s) described herein. Indeed, modifications and variations of the invention may be apparent to those skilled in the art upon reading this specification, and can be made without departing from its spirit and scope. The invention is therefore to be limited only by the terms of the claims, along with the full scope of equivalents to which the claims are entitled.

In the discussion below, “axial” refers to a direction that coincides with the longitudinal axis of the engine. “Radial” refers to a direction that is radial with respect to the longitudinal axis of the engine. “Circumferential” refers to a direction that corresponds to the circumference of a circle around the longitudinal axis of the engine. The “leading” edge/portion of a structure is the edge/portion that faces into the flow of the hot gases, i.e., faces “upstream”. The “trailing” edge/portion of a structure is the edge/portion that the faces away from the flow of the hot gases, i.e., faces “downstream”.

The present disclosure is directed to ceramic matrix composite (CMC) component(s), to ceramic fabric layup(s) (i.e., preform(s)) of the CMC components(s), and to method(s) for fabricating CMC components(s). In particular, the component(s) of the disclosure may be one or more airfoil(s) associated with one or more platform(s), which may be utilized in, e.g., turbomachinery, such as gas turbine engines. In some embodiments, the one or more airfoil(s) associated with one or more platform(s) of may be one or more vane(s), which may be utilized in, e.g., turbomachinery, such as gas turbine engines. As used herein, one or more airfoil(s) associated with one or more platform(s) may be preferred to as an “airfoil-platform” component.

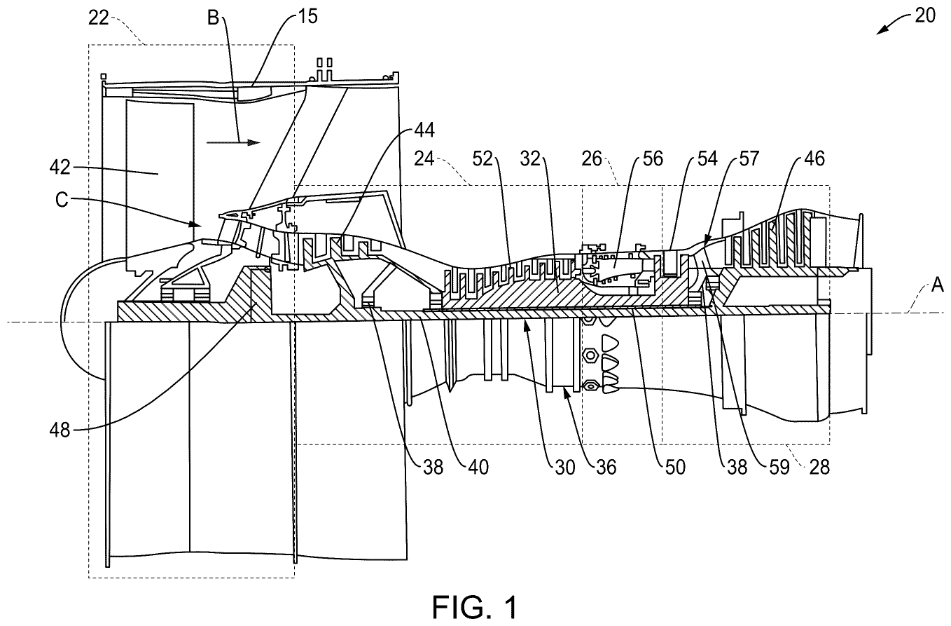

FIG. 1 schematically illustrates an example of a gas turbine engine 20 (in this example, an exemplary two-spool turbofan is illustrated) which includes a fan section 22, a compressor section 24, a combustor section 26, and a turbine section 28. Fan section 22 drives air along a bypass flow path B in a bypass duct defined within a housing 15, and also along a core flow path C for compression in compressor section 24, with subsequent introduction into combustor section 26, followed by expansion through turbine section 28. Although FIG. 1 depicts a two-spool turbofan gas turbine engine, it should be understood that the concepts described herein are not limited to use with two-spool turbofans engines and may be applied to other types of turbine engines.

Engine 20 generally includes a low speed spool 30 and a high-speed spool 32 mounted for rotation about an engine central longitudinal axis A, relative to an engine static structure 36, via several bearing systems 38. Various bearing systems 38 at various locations may alternatively or additionally be provided. The location of bearing systems 38 may be varied as appropriate to the application.

The low speed spool 30 generally includes an inner shaft 40 that interconnects, a first (or low) pressure compressor 44 and a first (or low) pressure turbine 46. Inner shaft 40 is connected to fan 42 through a speed change mechanism, which in this exemplary embodiment is illustrated as a geared structure 48 to drive fan 42 at a lower speed than the low speed spool 30. High speed spool 32 includes an outer shaft 50 that interconnects a second (or high) pressure compressor 52 and a second (or high) pressure turbine 54. Combustor 56 is positioned between high pressure compressor 52 and high-pressure turbine 54. A mid-turbine frame 57 of the engine static structure 36 may be arranged generally between the high-pressure turbine 54 and the low-pressure turbine 46. The mid-turbine frame 57 further supports bearing systems 38 in the turbine section 28. The inner shaft 40 and the outer shaft 50 are concentric and rotate via bearing systems 38 about the engine central longitudinal axis A which is collinear with their longitudinal axes.

The core air flow is first compressed by low pressure compressor 44, and then by the high-pressure compressor 52. Thereafter, the core air flow is mixed and burned with fuel in combustor 56, then expanded in high pressure turbine 54 and low-pressure turbine 46. The mid-turbine frame 57 includes airfoils 59 which are in the core airflow path C. The turbines 46 and 54 rotationally drive the respective low speed spool 30 and high-speed spool 32 in response to the expansion. It will be appreciated that each of the positions of the fan section 22, compressor section 24, combustor section 26, turbine section 28, and fan drive gear system 48 may be varied. For example, gear system 48 may be located aft of the low-pressure compressor, or aft of the combustor section 26 or even aft of turbine section 28, and fan 42 may be positioned forward or aft of the location of gear system 48.

The turbine section 28 includes at least one rotor and at least one blade extending radially outwardly from the rotor. The turbine section 28 may further include a blade outer air seal(s) (BOAS(s)). The blade outer air seal can be an assembly of a plurality of BOAS segments that together form an annular shaped shroud around the engine's central longitudinal axis A which is positioned between an outer casing of the engine and the turbine blade(s) of the turbine section.

A gas turbine engine, or other turbomachinery, can be provided with one or more airfoil(s). One or more airfoil(s) may be associated with one or more platform(s), which platform(s) may provide one or more functions, such as supporting one or more airfoil(s), providing attachment for one or more airfoil(s) to one or more other structure(s), and/or transferring one or more load from one or more airfoil(s) to one or more other structure(s). As used herein, one or more airfoil(s) associated with one or more platform(s) may be preferred to as an “airfoil-platform” component.

In embodiments, an airfoil-platform component may comprise one or more airfoil(s) extending between two platforms. In embodiments, an airfoil-platform component may comprise an airfoil extending between two platforms; such an airfoil-platform component may be referred to as a “vane”. A gas turbine engine can be provided with one or more vanes. A vane may also be known as a “turbine vane”, a “stator vane”, a “turbine stator vane”, or the like. Vane(s) may be located, as a non-limiting example, in a turbine section 28.

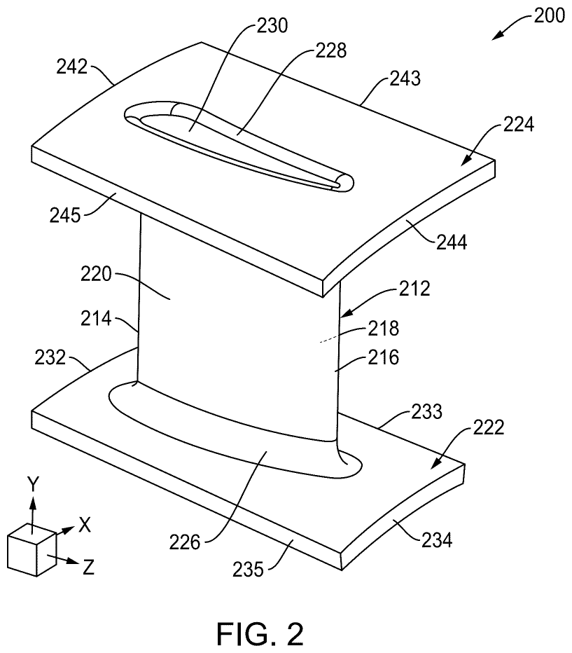

FIG. 2 is a perspective view of a non-limiting exemplary vane, which may be provided in, e.g., turbomachine, such as a gas turbine engine. Vane 200 includes airfoil 212 having airfoil leading edge side 214, airfoil trailing edge side 216, airfoil pressure side 218, and airfoil suction side 220. Trailing edge 216 is oppositely disposed from leading edge 214, and suction side 220 is oppositely disposed from pressure side 218. Airfoil 212 defines a gaspath-distal inner core/cavity 230. Vane 200 further includes inner diameter (ID) platform 222 and oppositely disposed outer diameter (OD) platform 224. ID platform 222 includes ID platform leading edge 232, ID platform pressure edge 233, ID platform trailing edge 234, and ID platform suction edge 235. OD platform 224 includes OD platform leading edge 242, OD platform pressure edge 243, OD platform trailing edge 244, and OD platform suction edge 245. Airfoil 212 extends between the ID platform 222 and OD platform 224, defining airfoil hollow core/open cavity 230. In exemplary vane 200, airfoil 212 extends between a gaspath-proximal side of ID platform 222 and a gaspath-proximal side of OD platform 224. However, one or more airfoil extending from a gaspath-proximal side of a single platform is also contemplated. ID fillet 226 can provide an aerodynamic transition between airfoil 212 and ID platform 222, and OD fillet 228 can provide an aerodynamic transition between airfoil 212 and OD platform 224.

Airfoil-platform component(s), such as, but not limited to vane(s), may comprise one or more CMC and may be fabricated using a layup technique during which one or more plies (sheets) of one or more ceramic fabric (which may be referred to as a “ceramic fabric ply” or a “ply”) may be formed into a preform comprising one or more airfoil(s) and one or more platform(s). In embodiments, such preforms may be fabricated using more than one layer of ceramic fabric (which may be referred to as a “ceramic fabric layer” or a “layer”). One or more layer may comprise one or more plies; in other words, more than one ply of ceramic fabric may be utilized to construct any given layer. In some embodiments, one or more layers may form a complete preform, while one or more other layers may form only one or more portion of a preform. It will be appreciated that different portions of a preform may comprise differing numbers of plies and/or layers. In the present disclosure, a ply a majority of which forms one or more portion of an airfoil may be referred to as an “airfoil ply”; and a ply a majority of which forms one or more portion of a platform may be referred to as a “platform ply”. One or more plies and/or layers may independently vary in thickness.

Additional ceramic materials, such as one or more insert comprising one or more axially aligned ceramic fibers that are not formed into fabric (e.g., one or more “noodle”) can be incorporated, as necessary or desirable, into a preform.

In an exemplary embodiment, ceramic fabrics can include, as non-limiting examples, fibers of carbon, silicon carbide, alumina, mullite, other suitable ceramic material, or any combination thereof. In exemplary embodiments, the ceramic fibers and/or fabrics can be reinforced (i.e., densified or infiltrated) with a ceramic matrix material, such as, but not limited to, carbon, silicon carbide, alumina, mullite, or other suitable ceramic material, or any combination thereof. Likewise, in exemplary embodiments, optional noodle(s) can comprise, as non-limiting examples, fibers of carbon, silicon carbide, alumina, mullite, or other suitable ceramic material, or any combination thereof. Fabrics, fibers, noodles, and matrixes may each, independently of one another, be comprised of the same or of different materials.

Airfoil-platform component(s) can include one or more curvatures, contours, bends, angles, and/or other geometrical features, which may be complex and may form angles of about 90 degrees, such as approximately 80 degrees to approximately 170 degrees, approximately 90 degrees to approximately 160 degrees, approximately 100 degrees to approximately 150 degrees, or approximately 110 degrees to approximately 140 degrees. Further, airfoil-platform component(s) may also be associated with additional structures, such as, for example, one or more flanges, which may be located on and/or extend from a platform, for example. Such additional structures may form angles of about 90 degrees, such as approximately 80 degrees to approximately 170 degrees, approximately 90 degrees to approximately 160 degrees, approximately 100 degrees to approximately 150 degrees, or approximately 110 degrees to approximately 140 degrees. Such additional structures may be fabricated with one or more airfoil-platform component(s); for example, a preform comprising airfoil(s), platform(s), and one or more additional structure(s) may be fabricated.

While airfoil-platform component(s), including but not limited to those associated with one or more flanges or other structures, can include one or more curvatures, contours, bends, angles, and/or other geometrical features, which may be complex, ceramic fabric(s) may have minimum bend radii. A minimum bend radius may be the radius at which a ceramic fabric ply (sheet) and/or ceramic fiber breaks, frays, cracks, and/or otherwise fails. Minimum bend radius may vary between ceramic fabric(s), and may be affected by multiple factors, such as, for example, the composition of the ceramic fibers, fabric architecture (e.g., woven, braided, unidirectional, etc.), fabric layup orientation, other factors, and/or any combination of factors. As non-limiting examples, for SiC-SiC CMCs, a minimum bend radius could be below 0.02″ for woven fabric, and below 0.015″ for braided fabric. One of ordinary skill in the art can, using routine methods, determine minimum bend radi(us) for given ceramic fabric(s).

Due, among other considerations, to the minimum bend radii of ceramic fabric(s), in fabricating airfoil(s) associated with one or more platforms, flanges, or other structures, it may be desirable (i) to form one or more layer(s) from more than one ceramic fabric ply per layer and/or (ii) to split and rejoin a ceramic fabric ply and/or layer, either or both of which ((i) and/or (ii)) may, in embodiments, necessitate joints between plies and/or between sections of a layer. Each joint may independently be, for example, a butt joint or an overlapping joint, and may further include stitches, which may stabilize structures during layup. It will be appreciated that different portions of a preform may comprise differing numbers of plies.

While it may be desirable (i) to form one or more layer(s) from more than one ceramic fabric ply per layer and/or (ii) to split and rejoin a ceramic fabric ply and/or layer, it may also be desirable to increase the surface area of ceramic fabric that is continuous (lacking joints) and/or to increase the number of continuous ceramic fibers in one or more location. Continuous ceramic fabric and/or fibers may provide benefits, such as increased strength, increased load transferring capacity, and/or the like.

It has been realized that there may be certain structural locations of airfoil-platform component(s) that may be preferable locations for any joint(s) between plies. Likewise, it has been realized that there may be certain structural locations of airfoil-platform component(s) where it may be preferable for one or more ceramic fabric layer, ply, and/or fiber to be continuous or relatively continuous, i.e., where it may be preferable to decrease the number of (or even to eliminate) any joint(s) between plies and/or layers. For example, it may be desirable for one or more ceramic fabric layer, ply, and/or fiber to be continuous or relatively continuous at the location of curvatures, contours, bends, angles, and/or other geometrical features. Mechanisms that may accommodate both (i) a desire to increase continuity and (ii) a desire to avoid and/or decrease bending in a radius less than a minimum bend radius are therefore desirable. One such mechanism may include the use of one or more “tab”.

In embodiments, one or more layer or ply may comprise one or more portions that may form a curve, a bend, a fold, or the like that spans between an airfoil and a platform, between an airfoil and a flange, and/or between a platform and a flange, as non-limiting examples. Such portion may form one or more fillet. Such a portion may be referred to as a “tab”. For convenience, a ply comprising one or more tab may be referred to as a “tab ply”.

For example, in one or more layers, a ply forming the entirety or a portion of a layer of one or more airfoil may comprise one or more tabs that may fold into and form one or more portion of a layer of one or more platform. As another example, in one or more layers, a ply forming the entirety or a portion of a layer of one or more platform may comprise one or more tabs that may fold into and form one or more portion of a layer of one or more flange. As yet another example, in one or more layers, a ply forming the entirety or a portion of a layer of one or more airfoil may comprise one or more tabs that may fold into and form one or more portion of a layer of one or more platform and may further fold into and form one or more portion of a layer of one or more flange. As yet another example, in one or more layers, a ply forming the entirety or a portion of a layer of one or more platform may comprise one or more tabs that may fold into and form one or more portion of a layer of one or more airfoil. As another example, in one or more layers, a ply forming the entirety or a portion of a layer of one or more flange may comprise one or more tabs that may fold into and form one or more portion of a layer of one or more platform. As yet another example, in one or more layers, a ply forming the entirety or a portion of a layer of one or more flange may comprise one or more tabs that may fold into and form one or more portion of a layer of one or more platform and may further fold into and form one or more portion of a layer of one or more airfoil. As still another example, a ply forming the entirety or a portion of a layer of one or more platform may comprise one or more tabs that may fold into and form one or more portion of a layer of one or more airfoil and one or more tabs that fold into and form one or more portion of a layer of one or more flange. Other configurations are also contemplated.

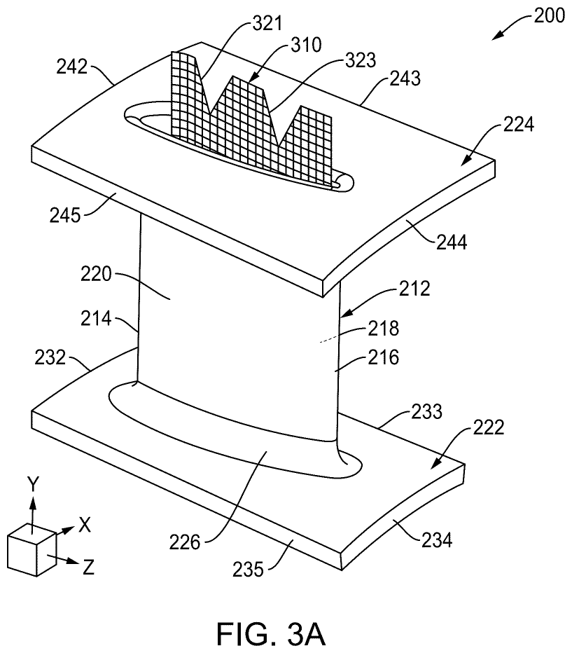

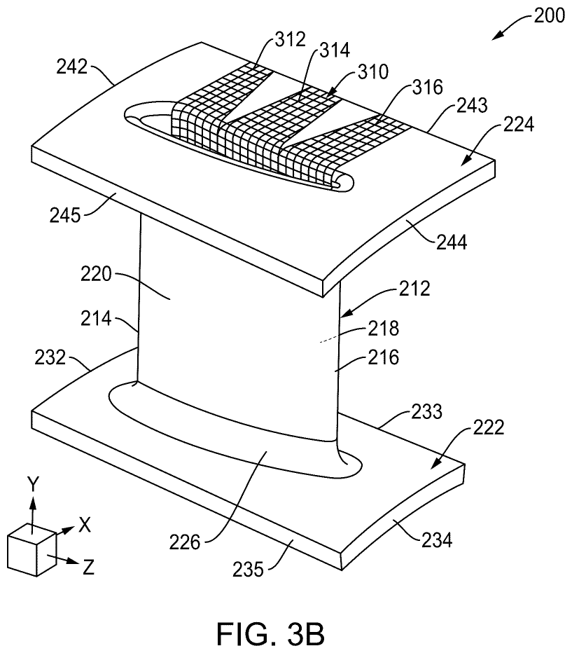

In embodiments, one or more tabs may be formed from one or more ply by cutting the ceramic fabric of a ply to facilitate curving it around a curve, such as a curve at a junction between an airfoil and a platform (e.g., a fillet). In embodiments, cuts may form roughly triangular darts. Portions formed by cutting the fabric and/or darting the fabric may be referred to as tabs and may allow the ceramic fabric lying in one plane to span a curve and lie flat or relatively flat and/or relatively undistorted in a second plane. In embodiments wherein darts are used, roughly triangular spaces may exist that are not covered by tabs. In such embodiments, roughly triangular plies of fabric optionally may be cut to fill in the spaces; alternatively, the spaces may be filled by other layers. Exemplary tabs formed by darts are illustrated in FIG. 3A and FIG. 3B, each of which illustrates a perspective view of view of exemplary airfoil 200. In FIG. 3A, exemplary tab ply 310 can be seen forming part of and emerging from airfoil pressure side 218. In FIG. 3A, tab ply 310 has not yet been folded onto OD platform 224. Dart cuts 321 and 323 are made in tab ply 310, and roughly triangular pieces of fabric are removed. In FIG. 3B, three tabs formed from tab ply 310 are shown folded onto OD platform 224 generally in the direction of OD platform pressure edge 243. Tabs 312, 314, and 316 are shown. For additional clarity, no tab ply is shown forming part of airfoil suction side 220. However, in embodiments, such a ply, with or without tabs, may be present. Such a ply may be continuous with tab ply 310, or may be split, for example, at or near the leading edge and/or at or near the trailing edge. Likewise, for additional clarity, no tabs are shown forming any portion of ID platform 222; nevertheless, one or more such tabs are contemplated. Although an exemplary plain weave is schematically illustrated, other weaves are contemplated, as are braided fabrics.

A first tab ply may comprise one or more fibers that extend from at least a one area of a first platform into a first airfoil side and that optionally may also extend from the first airfoil side into at least one area of a second platform. In embodiments, second tab ply may extend from at least a one area of a first platform into a second airfoil side and, optionally may also extend from the second airfoil side into at least one area of a second platform. Each tab ply may independently comprise (i) a side portion that forms a portion of the first airfoil side and (ii) at least one first platform portion that forms at least a portion of a fillet and at least a portion of at least one area of the first platform, and, optionally, (iii) at least one second platform portion that forms at least a portion of another fillet and at least a portion of at least one area of a second platform. As explained herein, a tab ply may comprise dart cuts, which may form more than one tab from a single tab ply.

A tab ply may comprise a plurality of longitudinal ceramic fibers. A “longitudinal” fiber may be one that (i) comprises at least one portion that forms a part of at least one airfoil, (ii) that comprises at least one portion that extends generally in a direction between the ID platform and the OD platform, and/or (iii) (i) and/or (ii). In other words, a “longitudinal” fiber may be one that, when forming a portion of an airfoil, extends generally in the direction of the Y axis in FIGS. 2, 3A, 3B, 4A, 4B, and 5. Each longitudinal fiber may also, independently, extend onto and form part of at least one platform. Each longitudinal ceramic fiber may independently comprise (i) a first side portion length, the first side portion length forming a portion of an airfoil side portion of the tab ply, (ii) a first platform portion length forming a portion of the first platform portion of the tab ply, and, optionally, (iii) a second platform portion length forming a portion of the second platform portion of the tab ply. In some embodiments, each longitudinal ceramic fiber may independently be continuous along its entire length or along only one or more portion of its length.

Tab(s) may increase the number of continuous ceramic fibers in one or more location and/or increase the continuous surface area of ceramic fabric in one or more location, as compared to one or more joint. In embodiments, tab(s) may be used to transfer one or more load from a first location to a second location. However, due properties of ceramic fabric(s), such as minimum bend radii, even when dart cuts are employed, ceramic fabric tabs have a natural tendency to lie in a given direction; this direction may be referred to as “natural”, “straight”, “undistorted”, “unskewed” or the like. A tab placed to lie at such an angle may be referred to as a “straight” tab, an “undistorted” tab”, an “unskewed” tab, or the like. As discussed herein, darts may be removed from a ceramic fabric ply to facilitate formation of tabs that allow the ceramic fabric lying in one plane to span a curve and lie flat or relatively flat and/or relatively undistorted in a second plane. Exemplary tabs 312, 314, and 316 illustrated in FIG. 3B are exemplary unskewed tabs.

In some embodiments, at least a first portion of a longitudinal ceramic fiber of a tab ply may extend from an airfoil into a first platform at a first unskewed angle and, optionally, at least a second portion of a longitudinal ceramic fiber of a tab ply may extend from an airfoil into a second platform at a unsecond skewed angle. Such a longitudinal ceramic fiber may be referred to as an “unskewed” fiber, an “unskewed” ceramic fiber, an “unskewed” longitudinal fiber, or the like. A first unskewed angle and a second unskewed angle may be the same or different angles; i.e., a first unskewed angle may be of the same degree as a second unskewed angle or a first unskewed angle may be of a different degree as a second unskewed angle.

In some embodiments, (A) one or more tab of one or more tab ply may enter a first platform in a first area of the platform and may not be angled towards a second area of the first platform; (B) one or more portion of one or more tab of one or more tab ply forming one or more area of a first platform may comprise a majority of longitudinal ceramic fibers that each independently extend at an unskewed angle; and/or (C) any combination of (A) and/or (B). Such a tab may be referred to as an “unskewed” tab or the like.

In some embodiments, a tab ply comprising one or more first unskewed tab forming at least a portion of a first platform may also comprise a second unskewed tab forming at least a portion of a second platform. A first unskewed tab may lie at a first unskewed angle, and a second unskewed tab may lie at a second unskewed angle, and the first unskewed angle and the second unskewed angle may be the same or different angles; i.e., a first unskewed angle may be of the same degree as a second unskewed angle or a first unskewed angle may be of a different degree as a second unskewed angle.

Unskewed tabs may be fabricated and may lay relatively flat (or “undistorted”) when extending from a pressure side or a suction side of one or more airfoil in a natural direction. Accordingly, in embodiments, unskewed tabs may be useful to transfer one or more loads and from a pressure side of an airfoil to and/or towards one or more pressure edge of one or more platform and/or to transfer one or more loads from a suction side of an airfoil to and/or towards one or more suction edge of one or more platform. However, due to the small radii of curvature of the leading edge and trailing edge of an airfoil, location of tabs in these areas may be difficult to fabricate. Furthermore, as can be seen in FIG. 3B, unskewed tabs produced by use of dart cuts to remove material may reduce the number of longitudinal fibers that extend continuously from an airfoil to a platform edge.

Despite such limitations, it may be desirable to transfer one or more load from an airfoil or portion thereof to or towards a leading edge of one or more platform and/or to or towards a trailing edge of one or more platform. It may also be desirable to transfer one or more loads from one or more platform or portion thereof to one or more flange or other support element or portion thereof, and it may be desirable to locate one or more flange or support element at or near one or more leading edge of a platform or one or more trailing edge or a platform. In embodiments, it may be desirable to transfer one or more loads from an airfoil or portion thereof to one or more leading edge of a platform or portion thereof and further transfer the load from the platform or portion thereof to a flange or other support element or portion thereof located at or towards the leading edge of the platform. Likewise, in embodiments, it may be desirable to transfer one or more loads from an airfoil or portion thereof to one or more trailing edge of a platform or portion thereof and further transfer the load from the platform or portion thereof to a flange or other support element or portion thereof located at or towards the trailing edge of the platform. Accordingly, it may be desirable to intentionally skew one or more tabs at one or more angle different from one or more angle at which the tab has a natural tendency to lie. Such an angle may be referred to as “unnatural”, “distorted”, “skewed”, or the like. A tab is intentionally skewed to lie at such an angle may be referred to as a “distorted” tab, a “skewed”, tab, or the like.

When one or more ceramic fabric is distorted, one or more properties of the fabric architecture, such as fiber spacing, relative angle between warp and weft fibers, and/or other properties, deviates further and further from the undistorted state. One or more tabs may be more or less skewed, i.e., more or less distorted. A range of skewed angles is therefore contemplated. A tab ply may be formed from a ceramic fabric; wherein the ceramic fabric may comprise a property of being less distorted when it lies at an unskewed angle and being more distorted when it lies at a skewed angle, thereby defining a range of skewed angles bounded at a lower end by an angle about 5 degrees skewed from a natural angle and bounded at a higher end by an angle about 90 degrees skewed from a natural angle; ranges of skewed angles, such as, for example, from about 5 degrees to about 90 degrees, from about 10 degrees to about 85 degrees, from about 15 degrees to about 80 degrees, from about 20 degrees to about 75 degrees, from about 25 degrees to about 70 degrees, from about 30 degrees to about 65 degrees, from about 35 degrees to about 60 degrees, from about 40 degrees to about 55 degrees, or from about 45 degrees to about 50 degrees from a natural angle are contemplated.

In some embodiments, at least a first portion of a longitudinal ceramic fiber of a tab ply may extend from an airfoil into a first platform at a first skewed angle within the range of skewed angles and, optionally, at least a second portion of a longitudinal ceramic fiber of a ply tab may extend from an airfoil into a second platform at a second skewed angle within the range of skewed angles. Such a longitudinal ceramic fiber may be referred to as a “skewed” fiber, a “skewed” ceramic fiber, a “skewed” longitudinal fiber, or the like. A first skewed angle and a second skewed angle may be the same or different angles; i.e., a first skewed angle may be of the same degree as a second skewed angle or a first skewed angle may be of a different degree as a second skewed angle.

In some embodiments, (A) one or more tab of one or more tab ply may enter a first platform in a first area of the platform and may be angled towards a second area of the first platform at one or more skewed angle; (B) one or more portion of one or more tab of one or more tab ply forming one or more area of a first platform may comprise one or more region in which a majority of longitudinal ceramic fibers each independently extend at at least one skewed angle; and/or (C) any combination of (A) and/or (B). Such a tab may be referred to as a “skewed” tab or the like.

In some embodiments, a tab ply comprising one or more first skewed tab forming at least a portion of a first platform may also comprise a second skewed tab forming at least a portion of a second platform. A first skewed tab may be skewed at a first skewed angle and a second tab may be skewed at second skewed angle, and the first skewed angle and the second skewed angle may be the same or different angles; i.e., a first skewed angle may be of the same degree as a second skewed angle or a first skewed angle may be of a different degree as a second skewed angle.

In some embodiments, a skewed tab may comprise longitudinal ceramic fibers each independently having various skewed angles in at least one area of a platform. Accordingly, in some embodiments, a skewed tab may comprise one or more gradient of skewed angles in at least one area of a platform and/or a skewed tab may comprise one or more stepwise change of skewed angles in at least one area of a platform.

In some embodiments, a skewed tab may comprise at least one region that is skewed and at least one region that is unskewed. In some embodiments, a skewed tab may lack or essentially lack unskewed regions. In some embodiments, a skewed tab may comprise one or more regions having a first skewed angle and one or more regions having a second skewed angle, or additional skewed regions, wherein the first and second and additional skewed regions have independently varying skewed angles. In some embodiments, a skewed tab may have a gradient of skewed angles and/or may have skewed regions between which the skewed angles vary in a stepwise manner. In some embodiments, a tab ply may comprise one or more skewed tab forming one or more area of a first platform and may comprise one or more unskewed tab forming one or more area of a second platform. In some embodiments, a tab ply may comprise (i) at least one first skewed tab forming a first area of a first platform, (ii) at least one first unskewed tab forming a second area of a first platform, (iii) at least one second skewed tab forming a first area of a second platform, (iv) at least one second unskewed tab forming a second area of a second platform, and/or (v) any combination of (i), (ii), (iii), and/or (iv).

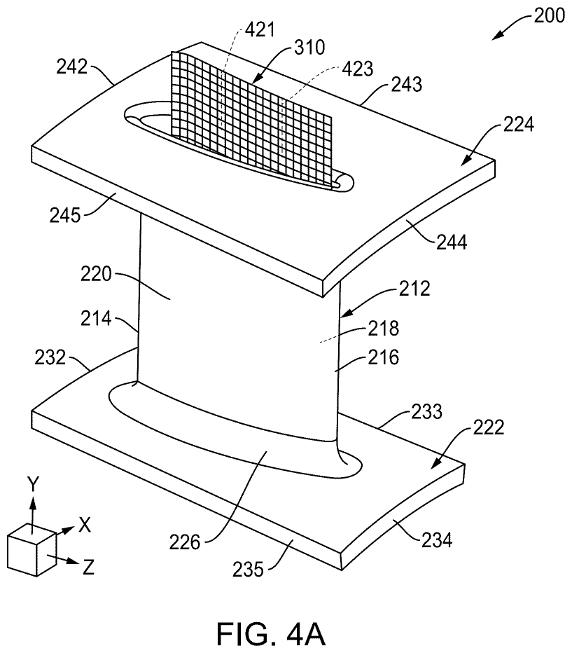

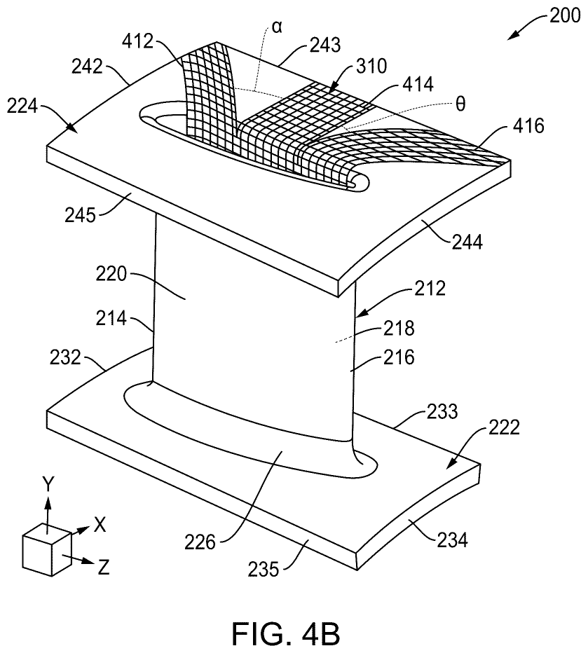

In embodiments, one or more skewed and/or one or more unskewed tabs may be formed from one or more ply by cutting the ceramic fabric of a ply to facilitate curving it around a curve, such as a curve at a junction between an airfoil and a platform (e.g., a fillet). In embodiments, the cuts may each be singular (or “straight”) cuts; in other words, in embodiments, roughly triangular dart cuts need not be utilized. FIG. 4A and FIG. 4B each illustrates a perspective view of view of exemplary vane 200. In FIG. 4A, tab ply 310 can be seen forming part of and emerging from airfoil pressure side 218. In FIG. 4A, tab ply 310 has not yet been folded onto OD platform 224. Single cuts 421 and 423 are made in tab ply 310 in a direction extending longitudinally with respect to a central axis of the airfoil. As may be seen, in embodiments, single cuts may (i) be made generally in a longitudinal direction with relation to longitudinal fibers, (ii) may reduce the number of longitudinal fibers cut, and/or (iii) any combination of (i) and/or (ii). Although dart cuts are also contemplated, single cuts may be preferred, in embodiments, as they may avoid, partially or completely, the reduction produced by a dart cut in the number of longitudinal fibers that extend continuously from an airfoil to a platform edge. In FIG. 3B, three tabs formed from tab ply 310 are shown folded onto OD platform 224. Exemplary unskewed tab 414 is folded generally in the direction of OD platform pressure edge 243. Longitudinal fibers of exemplary unskewed tab 414 lie at one or more natural or “unskewed” angle. Longitudinal fibers of unskewed tab 414 are exemplary unskewed longitudinal fibers. Exemplary skewed tab 412 is shown intentionally skewed generally in the direction of OD platform leading edge 242, and exemplary skewed tab 416 is shown intentionally skewed generally in the direction of OD platform trailing edge 244. Longitudinal fibers of each of exemplary skewed tab 412 and exemplary skewed tab 416 lie at one or more distorted or “skewed” angle. Longitudinal fibers of skewed tab 412 and longitudinal fibers of skewed tab 416 are exemplary skewed longitudinal fibers. Angle α and angle θ are each illustrated. Each of angle α and angle θ illustrates an angle of skew from a natural angle. Each of angle α and angle θ is an exemplary skewed angle. Each of angle α and angle θ may independently range from about 5 degrees to about 90 degrees, from about 10 degrees to about 85 degrees, from about 15 degrees to about 80 degrees, from about 20 degrees to about 75 degrees, from about 25 degrees to about 70 degrees, from about 30 degrees to about 65 degrees, from about 35 degrees to about 60 degrees, from about 40 degrees to about 55 degrees, or from about 45 degrees to about 50 degrees from a natural angle. Each of the longitudinal fibers of exemplary unskewed tab 414 lies at one or more natural (unskewed) angles, while each of the longitudinal fibers of each of exemplary skewed tabs 412 and 416 lies at one or more skewed angles. In embodiments, in an unskewed tab, each of the longitudinal fibers may lie at a different angle, but at least a majority, optionally all, of the fibers in an unskewed tab may lie at an unskewed angle. In embodiments, in a skewed tab, each of the longitudinal fibers may lie at a different angle, but at least a majority, optionally all, of the fibers in a skewed tab may lie at a skewed angle.

For additional clarity, no tab ply is shown forming part of airfoil suction side 220. However, in embodiments, such a ply, with or without tabs, may be present. Such a ply may be continuous with tab ply 310, or may be split, for example, at or near the leading edge and/or at or near the trailing edge. Likewise, for additional clarity, no tabs are shown forming any portion of ID platform 222; nevertheless, one or more such tabs are contemplated. Although an exemplary plain weave is schematically illustrated, other weaves are contemplated, as are braided fabrics.

In embodiments, one or more skewed tabs may be used to transfer one or more load (i) from one or more airfoil pressure side toward one or more of a leading edge and/or a trailing edge of one or more platform, (ii) from one or more airfoil suction side toward one or more of a leading edge and/or a trailing edge of one or more platform, and/or (iii) any combination of (i) and/or (ii).

One or more unskewed tabs, one or more skewed tabs, or any combination thereof may be used with various types of airfoil-platform component(s). Tabs are illustrated herein using a vane, which is a non-limiting example of an airfoil-platform component. Other types of airfoil-platform component(s) are contemplated. For example, exemplary vanes illustrated herein each comprise an inner diameter platform and an outer diameter platform; however, airfoil(s) associated with only one platform are contemplated.

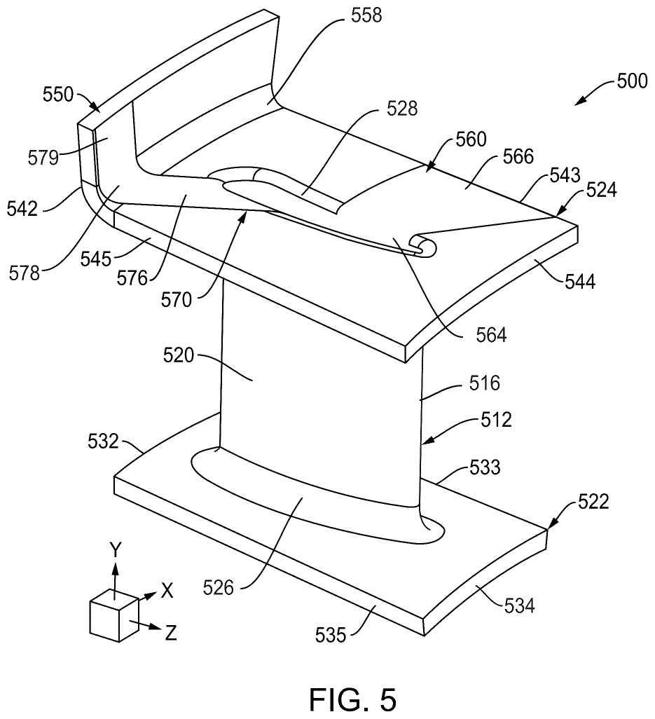

FIG. 5 is a perspective view of a non-limiting exemplary vane similar to vane 200, further comprising a non-limiting exemplary flange 550, one exemplary skewed tab ply 560, and one exemplary skewed tab ply 570. Exemplary vane 500 may be provided in, e.g., turbomachine, such as a gas turbine engine. Vane 500 includes generally includes components illustrated in vane 200 of FIG. 2, although some are unlabeled for additional clarity. Vane 500 includes airfoil 512 having an airfoil trailing edge side 516, an airfoil leading edge side (unlabeled for additional clarity) generally oppositely disposed from airfoil trailing edge side 516, an airfoil suction side 520, and an airfoil pressure side (unlabeled for additional clarity) generally oppositely disposed from airfoil suction side 520. Vane 500 further includes inner diameter (ID) platform 522 and oppositely disposed outer diameter (OD) platform 524. ID platform 522 includes ID platform leading edge 532, ID platform pressure edge 533, ID platform trailing edge 534, and ID platform suction edge 535. OD platform 524 includes OD platform leading edge 542, OD platform pressure edge 543, OD platform trailing edge 544, and OD platform suction edge 545. Airfoil 512 extends between the ID platform 522 and OD platform 524, defining an airfoil hollow core/open cavity, which is unlabeled for additional clarity. Vane 500 includes exemplary flange 550 extending from OD platform leading edge 542. As can be seen, flange 550 extends in a generally perpendicular direction from OD platform 524. ID fillet 526 can provide an aerodynamic transition between airfoil 512 and ID platform 522, OD fillet 528 can provide an aerodynamic transition between airfoil 512 and OD platform 524, and flange fillet 558 can provide an aerodynamic transition between OD platform 524 and flange 550.

Pressure side skewed tab 560 ply includes an airfoil side portion that is unlabeled for additional clarity, OD fillet skewed tab portion 564, and OD platform skewed tab portion 566. As can be seen, OD platform skewed tab portion 566 is skewed towards OD platform trailing edge 544 and is, or is essentially, unskewed towards OD platform leading edge 542. Suction side skewed tab ply 570 includes an airfoil side portion that is unlabeled for additional clarity, an OD fillet skewed tab portion that is unlabeled for additional clarity, OD platform skewed tab portion 576, flange fillet skewed tab portion 578, and flange skewed tab portion 579 extending from OD platform skewed tab portion 574. Flange skewed tab portion 578 extends to form at least a portion of at least one layer of flange 550.

Referring to FIG. 5, regarding pressure side skewed tab ply 560, in embodiments, any combination of unlabeled airfoil side portion, OD fillet skewed tab portion 564, and/or OD platform skewed tab portion 566 (i) may transfer one or more load from airfoil 512 towards OD platform pressure edge 543, (ii) may transfer one or more from airfoil 512 load towards OD platform trailing edge 544, or (iii) any combination of (i) and/or (ii). Regarding suction side skewed tab ply 570, in embodiments, any combination of unlabeled airfoil side portion, unlabeled OD fillet skewed tab portion, OD platform skewed tab portion 576, flange fillet skewed tab portion 578, and/or flange skewed tab portion 579 (i) may transfer one or more load from airfoil 512 towards OD platform suction edge 545; (ii) may transfer one or more load from airfoil 512 towards OD platform leading edge 542, (iii) may transfer one or more load from airfoil 512 towards flange 550, or (iv) any combination of (i), (ii), and/or (iii). In embodiments, other load transfers may not be excluded.

For additional clarity, no tabs are shown forming any portion of ID platform 522; nevertheless, one or more such tabs are contemplated. Further, for additional clarity, fibers forming ceramic fabric are not illustrated in FIG. 5, but it will be understood that ceramic fabric may be formed of fibers. In embodiments, airfoil portions of tab plies may be joined directly at the airfoil leading edge and trailing edge, for example. However, other configurations are contemplated; as a non-limiting example, the airfoil portions of tab plies may not be joined directly together one on or more of the leading airfoil edge and/or trailing airfoil edge; such airfoil portions may be, for example, indirectly joined by one or more other ply that is joined to each airfoil portion, may be left unjoined, or other configurations. As another example, airfoil portions of tab plies may be continuous with each other.

FIGS. 3A-5 illustrate non-limiting exemplary of arrangements of tab plies and tabs. Other embodiments with varying numbers and arrangements of tabs and tab plies are contemplated. As one non-limiting example, one or more tab plies may comprise one or more ID platform tab portion that is asymmetrical compared to one or more OD platform tab portion. For example, each of an OD platform tab portion and ID platform tab portion may independently be unskewed, partially skewed, or skewed. As another example, one or more tab ply may comprise one or more tab(s) that may be skewed to a different degree than one or more other tab(s). As another example, a tab ply may comprise different numbers of ID platform tab portion(s) and OD platform tab portion(s); e.g., a tab ply may comprise only one of an ID platform tab portion and OD platform tab portion or may comprise a plurality of ID tab portions and/or a plurality of OD tab portions; in other words, each of an OD platform tab portion and ID platform tab portion may independently be present or absent or may be present in different numbers. As another example, a tab ply may comprise one or more ID platform tab portion and OD platform tab portion, each of which may independently vary in size (e.g., width, length, and/or thickness), shape, and/or other characteristics.

Multiple layers may comprise one or more tab ply. One or more layer with one or more tab ply may be layered directly adjacent to one or more other layer with one or more tab ply. One or more layer without tab plies may be layered directly adjacent to one or more layer with one or more tab ply. In embodiments, one or more layers that is relatively proximal to one or more gaspath, such as one or more overwrap, may lack tab plies. One or more “gaspath overwrap” can be one or more most gaspath proximal layer of a vane and can form a part of and/or be exposed to one or more gaspath.

In an exemplary embodiment, a method of forming a ceramic matrix composite (CMC) vane including an inner diameter platform, an outer diameter platform, and an airfoil extending between the inner diameter platform and the outer diameter platform may include laying up a ceramic preform by arranging one or more ceramic fibers and/or one or more ceramic fabrics to form a preform having a desired shape. Typically, plies (sheets) of ceramic fabric may be wrapped around a suitably shaped mandrel to create a general shape of an airfoil having at least one hollow core. The rest of the preform for the vane component may be built outwards from the airfoil. Additional ceramic materials, such as inserts (e.g., “noodles”) can be incorporated, as necessary or desirable, into a preform. A tackifier composition of a polymer material in solution (e.g., polyvinyl alcohol in water, polyvinyl butyral in ethanol, etc.) can be applied to any of the fabrics, as needed, to facilitate handling and stabilization of a preform through subsequent processing.

Special tooling, as is known in the art, may be used to guide the layup of fabric plies to create a preform for a CMC vane. The exact order of operations may be determined during a manufacturing trial, but technicians typically may use tools/tooling made from plastic or metal to layup plies to create platforms the preform, with one or more overwrap plies being applied last. The completed preform may then be put into specialized tooling to hold its shape during the densification/reinforcement/infiltration processes that may be used to complete manufacture of the CMC vane.

A preform can be optionally debulked before densification with matrix to form the final CMC component. In embodiments, one or more portion of one or more tab ply may extend beyond the remainder of the preform. Such extending portions may be trimmed off prior to and/or after densification. Densification can be carried out using chemical vapor infiltration (CVI). Other densification techniques are contemplated herein, such as one or a combination of slurry infiltration, melt infiltration, and polymer infiltration and pyrolysis. Such techniques can supplement the CVI process. Protective coatings for the CMC component (e.g., thermal barrier coatings, environmental barrier coatings (EBC), etc.) can optionally be applied after densification.

In exemplary embodiments, ceramic fabrics may include ceramic fibers arranged in one of various two or three-dimensional architectures. In exemplary embodiments, ceramic fabrics may include ceramic fabrics with braided architecture (such as, e.g., bi- and/or triaxial braided architecture), ceramic fabrics with knit architecture, and/or ceramic fabrics with weave architecture. Non-limiting examples of woven ceramic fabric include a two-dimensionally woven ceramic fabric, such as 8-harness satin weave, other satin weaves (3-, 5-, 10-harness, etc.), plain weaves, and/or twill weaves. Ceramic comprising non-woven (e.g., chopped, felted, etc.) fibers are also contemplated herein. Uniaxial ceramic fiber architectures are also contemplated herein.

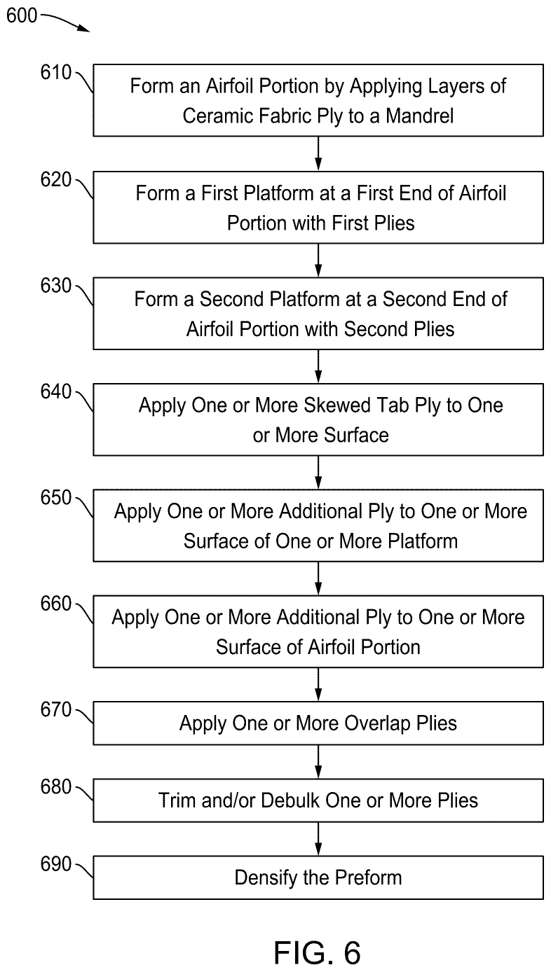

One or more embodiments of the present disclosure further relate to an exemplary method 600 of forming exemplary CMC vane 200. A similar method may be used to form exemplary vane 500. Referring to FIG. 6, in an embodiment, method 600 may include a step 610 of forming an airfoil portion 212 by applying layers of ceramic fabric ply to a mandrel to form an airfoil portion of a preform.

Method 600 may further include a step 620 of forming a first platform at a first end of airfoil portion 212 of the preform with one or more plies, which may optionally be donut plies, such that airfoil portion 212 extends through the first platform. The first platform can be ID platform 222 or OD platform 224. In a step 630, a second platform may be formed at a second end of airfoil portion 212 of the preform with one or more plies, which may optionally be donut plies, such that airfoil portion 212 extends through the second platform. The second platform can be ID platform 222 or OD platform 224. It will be appreciated that when the first platform is ID platform 222, the second platform is preferably OD platform 224; and when the first platform is OD platform 224, the second platform is preferably ID platform 222; however, two relatively uncurved platforms are also contemplated. Formation of one or more flange is also contemplated.

In a step 640, one or more tab ply may be applied to one or more surface of the preform. One or more tab ply may comprise at least one airfoil portion; one or more tab portion; and optionally one or more flange tab portion. One or more tab ply may wrap and/or bend around a curve and/or bend and may be applied to more than one surface, such as a surface of an airfoil, a surface of a platform, a surface of a flange, and/or any combination thereof. One or more tab ply may be applied to one or more fillet. One or more tab ply may be skewed or may be unskewed.

In an optional step 650, one or more additional platform (optionally donut) ply may be applied to one or more surface of one and/or each of the first platform and the second platform of the preform.

In an optional step 660, one or more additional ply may be applied to one or more surface of airfoil portion 212 of the preform.

Steps 640, 650, and 660 may be performed in any order and may optionally be repeated independently in any order.

In a step 670, one or more overwrap plies may be applied to one or more surfaces of at least a portion of one or more of the first platform, the second platform, and airfoil portion 212 of the preform; overwrap ply(s) may form one or more gaspath surfaces of a vane.

In an optional step 680, one or more plies of the preform may be trimmed and/or debulked.

In Step 690, the preform may be densified.

The below-described advantages and/or other advantages may result from the compositions and/or processes described herein. However, it should be understood that the disclosure is directed to the described composition and/or processes, regardless of whether the below-described and/or other advantages are achieved.

One or more airfoil-platform component(s) comprising one or more skewed tab may comprise relatively increased numbers and/or density of continuous load carrying fibers in one or more desired direction(s) as compared to one or more similar airfoil-platform component(s) lacking skewed tab(s) plies and/or comprising fewer or differently formed or arranged tab(s). In embodiments, tab(s) may be shaped, oriented, and/or otherwise formed to increase and/or optimize effective load transfer between one or more airfoil and one or more platform sections. Any increase and/or optimization of effective load transfer between one or more airfoil and one or more platform sections may be beneficial for a component's structural capability.

While the present disclosure has been particularly described, in conjunction with specific preferred embodiments, it is evident that many alternatives, modifications and variations will be apparent to those skilled in the art in light of the foregoing description. It is therefore contemplated that the appended claims will embrace any such alternatives, modifications and variations as falling within the true scope and spirit of the present disclosure.

1. A ceramic matrix composite (CMC) component or a preform for making a CMC component, comprising:
(a) a first platform;
(b) an airfoil extending from the first platform, the airfoil comprising a first airfoil side and a second airfoil side; and
(c) a first tab ply extending from at least the first airfoil side onto the first platform and comprising (i) at least one airfoil side portion that forms at least a portion of at least the first airfoil side and (ii) at least one first skewed tab portion that forms at least a portion of a first area of the first platform, wherein the first airfoil side is a pressure side of the first airfoil or a suction side of the first airfoil, and the first skewed tab portion is angled away from the first airfoil side toward a leading edge of the first platform or toward a trailing edge of the first platform at at least one first skewed angle, wherein the first skewed angle is different from one or more angle at which the first skewed tab portion has a natural tendency to lie.

2. The CMC component or preform of claim 1, further comprising:
a second tab ply extending from at least the second airfoil side onto the first platform and comprising (i) at least one airfoil side portion that forms at least a portion of the second airfoil side and (ii) at least one second skewed tab portion that forms at least a portion of a second area of the first platform, wherein the second airfoil side is a pressure side of the first airfoil or a suction side of the first airfoil, and the second skewed tab portion is angled away from the second airfoil side toward the leading edge of the first platform or toward the trailing edge of the first platform at at least one second skewed angle, wherein the second skewed angle is different from one or more angle at which the second skewed tab portion has a natural tendency to lie.

3. The CMC component or preform of claim 1, wherein the first tab ply further comprises:
at least one first unskewed tab portion that forms at least a portion of a third area of the first platform.

4. The CMC component or preform of claim 2, wherein the second tab ply further comprises:
at least one second unskewed tab portion that forms at least a portion of a fourth area of the first platform.

5. The CMC component or preform of claim 1, further comprising:
a second platform, wherein the airfoil extends between the first platform and the second platform, wherein
the first tab ply extends from at least the first airfoil side onto the second platform and further comprises at least one second skewed tab portion that forms at least a portion of a first area of the second platform, wherein the first airfoil side is a pressure side of the first airfoil or a suction side of the first airfoil, and the second skewed tab portion is angled away from the first airfoil side toward a leading edge of the second platform or toward a trailing edge of the second platform at at least one second skewed angle, wherein the second skewed angle is different from one or more angle at which the second skewed tab portion has a natural tendency to lie.

6. The CMC component or preform of claim 2, further comprising:
a second platform, wherein the airfoil extends between the first platform and the second platform, wherein
the first tab ply extends from at least the first airfoil side onto the second platform and further comprises at least one third skewed tab portion that forms at least a portion of a first area of the second platform, wherein the first airfoil side is a pressure side of the first airfoil or a suction side of the first airfoil, and the third skewed tab portion is angled away from the first airfoil side toward a leading edge of the second platform or toward a trailing edge of the second platform at at least one third skewed angle, wherein the third skewed angle is different from one or more angle at which the third skewed tab portion has a natural tendency to lie; and
the second tab ply extends from at least the second airfoil side onto the second platform and further comprises at least one fourth skewed tab portion that forms at least a portion of a second area of the second platform, wherein the second airfoil side is a pressure side of the first airfoil or a suction side of the first airfoil, and the fourth skewed tab portion is angled away from the second airfoil side toward a leading edge of the second platform or toward a trailing edge of the second platform at at least one fourth skewed angle, wherein the fourth skewed angle is different from one or more angle at which the fourth skewed tab portion has a natural tendency to lie.

7. The CMC component or preform of claim 5, further wherein the first tab ply extends from at least the first airfoil side onto the second platform and further comprises at least one first unskewed tab portion that forms at least a portion of a second area of the second platform.

8. The CMC component or preform of claim 6, further wherein the second tab ply extends from at least the second airfoil side onto the second platform and further comprises at least one first unskewed tab portion that forms at least a portion of a third area of the second platform.

9. The CMC component or preform of claim 5, wherein the first tab ply comprises at least one or at least a plurality of longitudinal ceramic fiber that is continuous along its entire length from the first skewed tab portion to the second skewed tab portion.

10. The CMC component or preform of claim 6, wherein the second tab ply comprises at least one or at least a plurality of longitudinal ceramic fiber that is continuous along its entire length from the second skewed tab portion to the fourth skewed tab portion.

11. The CMC component or preform of claim 2, wherein the first tab ply and the second tab ply together form one ply that is at least partially continuous circumferentially around the airfoil.

12. A method of forming a ceramic matrix composite (CMC) component, comprising:
(a) forming an airfoil by applying one or more ceramic fabric plies to a mandrel, the airfoil comprising a first airfoil side and a second airfoil side;
(b) forming a first platform at a first end of the airfoil by applying one or more ceramic fabric plies, (i) the first platform and the first airfoil side forming a first fillet at an interface formed therebetween and (ii) the first platform and the second airfoil side forming a second fillet at an interface formed therebetween;
(c) providing at least one ceramic fabric first tab ply; the first tab ply comprising (i) at least one first airfoil side portion (ii) at least one first platform portion; and
(d) applying the first tab ply by (i) applying the at least one first airfoil side portion of the first tab ply to the first airfoil side and (ii) wrapping at least one of the at least one first platform portion of the first tab ply around at least a portion of the first fillet onto the first platform at at least one first skewed angle, such that a first skewed tab is formed, the first skewed tab comprising at least one first skewed tab portion; wherein the first airfoil side is a pressure side of the first airfoil or a suction side of the first airfoil, and the first skewed tab portion is angled away from the first airfoil side toward a leading edge of the first platform or toward a trailing edge of the first platform at at least the first skewed angle, wherein the first skewed angle is different from one or more angle at which the first skewed tab portion has a natural tendency to lie.

13. (canceled)

14. (canceled)

15. The method of claim 12, further comprising:
(e) providing at least one ceramic fabric second tab ply; the second tab ply comprising (i) at least one first airfoil side portion (ii) at least one first platform portion; and
(f) applying the second tab ply by (i) applying the at least one first airfoil side portion of the second tab ply to the second airfoil side and (ii) wrapping at least one of the at least one first platform portion of the second tab ply around at least a portion of the second fillet onto the first platform at at least one second skewed angle, such that a second skewed tab is formed, the second skewed tab comprising at least one second skewed tab portion; wherein the second airfoil side is a pressure side of the first airfoil or a suction side of the first airfoil, and the second skewed tab portion is angled away from the second airfoil side toward a leading edge of the first platform or toward a trailing edge of the first platform at at least the second skewed angle, wherein the second skewed angle is different from one or more angle at which the second skewed tab portion has a natural tendency to lie.

16. The method of claim 12,
wherein the first tab ply further comprises (iii) at least one second platform portion;
the method further comprising:
(e) forming a second platform at a second end of the airfoil by applying one or more ceramic fabric plies; (i) the second platform and the first airfoil side forming a third fillet at an interface formed therebetween and (ii) the second platform and the second airfoil side forming a fourth fillet at an interface formed therebetween; and
(f) wrapping at least one of the at least one second platform portion of the first tab ply around at least a portion of the third fillet onto the second platform at at least one second skewed angle, such that a second skewed tab is formed, the second skewed tab comprising at least one second skewed tab portion; wherein the second skewed tab portion is angled away from the first airfoil side toward a leading edge of the second platform or toward a trailing edge of the second platform at at least the second skewed angle, wherein the second skewed angle is different from one or more angle at which the second skewed tab portion has a natural tendency to lie, and wherein the first skewed angle and the second skewed angle are the same or different angles.

17. The method of claim 15,
wherein the first tab ply further comprises (iii) at least one second platform portion and the second tab ply further comprises (iii) at least one second platform portion;
the method further comprising:
(g) forming a second platform at a second end of the airfoil by applying one or more ceramic fabric plies; (i) the second platform and the first airfoil side forming a third fillet at an interface formed therebetween and (ii) the second platform and the second airfoil side forming a fourth fillet at an interface formed therebetween;
(h) wrapping at least one of the at least one second platform portion of the first tab ply around at least a portion of the third fillet onto the second platform at at least one third skewed angle, such that a third skewed tab is formed, the third skewed tab comprising at least one third skewed tab portion; wherein the third skewed tab portion is angled away from the first airfoil side toward a leading edge of the second platform or toward a trailing edge of the second platform at at least the third skewed angle, wherein the third skewed angle is different from one or more angle at which the third skewed tab portion has a natural tendency to lie;
(i) wrapping at least one of the at least one second platform portion of the second tab ply around at least a portion of the fourth fillet onto the second platform at at least one fourth skewed angle, such that a fourth skewed tab is formed, the fourth skewed tab comprising at least one fourth skewed tab portion; wherein the fourth skewed tab portion is angled away from the second airfoil side toward a leading edge of the second platform or toward a trailing edge of the second platform at at least the fourth skewed angle, wherein the fourth skewed angle is different from one or more angle at which the fourth skewed tab portion has a natural tendency to lie; and
wherein the first skewed angle, the second skewed angle, and the third skewed angle, and the fourth skewed angle are independently the same or different angles.

18. (canceled)

19. The CMC component or preform of claim 1, further comprising:
(d) at least one first flange extending in a generally perpendicular direction from the leading edge of the first platform; further wherein:
the first skewed tab portion is angled from the first airfoil side toward the leading edge of the first platform and the first tab ply further comprises at least one first flange portion extending from the at least one first skewed tab portion and forming at least a portion of a first area of the first flange.

20. The CMC component or preform of claim 1, further comprising:
(d) at least one first flange extending in a generally perpendicular direction from the trailing edge of the first platform; further wherein:
the first skewed tab portion is angled from the first airfoil side toward the trailing edge of the first platform and the first tab ply further comprises at least one first flange portion extending from the at least one first skewed tab portion and forming at least a portion of a first area of the first flange.

21. The method of claim 12, wherein:
the first tab ply further comprises (iii) at least one first flange portion extending from the at least one first skewed tab portion; and
the method further comprises:
forming at least one first flange extending in a generally perpendicular direction from the leading edge of the first platform and applying at least one of the at least one first flange portion of the first tab ply to the first flange, such that the first flange portion of the first tab ply forms at least a portion of a first area of the first flange.

22. The method of claim 12, wherein:
the first tab ply further comprises (iii) at least one first flange portion extending from the at least one first skewed tab portion; and
the method further comprises:
forming at least one first flange extending in a generally perpendicular direction from the trailing edge of the first platform and applying at least one of the at least one first flange portion of the first tab ply to the first flange, such that the first flange portion of the first tab ply forms at least a portion of a first area of the first flange.
